(19) United States
(12) Patent Application Publication
(10) Pub. No.: US 2007/0242035 A1
(43) Pub. Date: Oct. 18, 2007

(54) Wireless network phone

(75) Inventor: Robert Tsao, Taipei City (TW)

Correspondence Address: ROBERT TSAO, 20525 Via Talavera, Yorba Linda, CA, 92887, US

(73) Assignee: GOOD WAY TECHNOLOGY CO., LTD

(21) Appl. No.: 11/402,785

(22) Filed: Apr. 13, 2006

(51) Int. Cl. G09G 5/00

(52) U.S. Cl. 345/156

(57) ABSTRACT

The present invention discloses a wireless network phone that includes a wireless transmitter connected to a computer system and a wireless phone connected to the wireless transmitter for transmitting data signals, wherein the wireless phone comes with an Internet dialing/receiving telephone mode, a PowerPoint presentation mode, a file/data mode, and a multimedia mode for downloading music and voices from a network to the wireless phone, and a key on the wireless phone is selected to execute a mode and send a control signal to the wireless transmitter, such that the wireless transmitter will input a signal into the computer system to execute a corresponding application program, and the wireless phone can transmit control commands to the computer system directly, and the wireless phone can achieve the effects of conducting a wireless remote-control presentation, a multimedia playback, and a data transmission or synchronization.

### FIELD OF THE INVENTION

The present invention relates to a wireless network phone that can transmit control commands from a wireless phone to a computer system, such that the wireless phone has the effects of conducting a wireless remote-control PowerPoint presentation, a multimedia playback, and a data transmission or synchronization.

### BACKGROUND OF THE INVENTION

Since Internet has become a part of our life, therefore its related industrial technology is upgraded constantly and we can search our desired information from the Internet or trade commercial products. We also can contact other people directly by an instant message (IM) software such as SKYPE or MSN with short messages, video conferences, and voice systems, and the communication mode by a voice system is gradually replacing traditional typing. The prior art voice system requires an earphone and a microphone and uses a USB transmission line to connect a computer system. As the network periphery technology advances, network phones also use a wireless transmission to replace the traditional transmission line, and thus providing tremendous convenience to users. However, users usually have to carry many 3C electronic products such as a MP3 player, a multimedia player, a remote controller for conducting presentation and a laser pointer with them, and thus users have to carry many additional products all the time. If a user leaves out one of these electronic products, it will be very inconvenient to the user who needs to carry a notebook computer for making a presentation or a speech very often. Thus, it is obvious that it brings tremendous convenience to users if we can integrate most of the 3C products.

### SUMMARY OF THE INVENTION

In view of the shortcoming of the prior art that requires users to carry many electronic products, the inventor of the present invention based on years of experience in the related industry to conduct extensive researches and experiments, and finally invented a wireless network phone that can transmits control commands directly from a wireless phone to a computer system, so that the wireless phone has the functions of conducting a wireless remote-control presentation or a multimedia playback, and receiving emails.

Therefore, it is a primary objective of the present invention to provide a wireless network phone that can transmit control commands from a wireless phone to a computer system, such that the wireless phone has the function of conducting a wireless remote-control PowerPoint presentation, a multimedia playback, and a data transmission or synchronization.

To achieve the foregoing objective, the present invention provides a wireless network phone that comprises a wireless transmitter (or a wire dongle) connected to a computer system and a wireless phone connected to the wireless transmitter for transmitting data signals, wherein the wireless phone comes with a network dialing/receiving telephone mode, a PowerPoint presentation mode, a file/data mode, and a multimedia mode for downloading network information to the wireless phone for playbacks. A key on the wireless phone is selected and pressed to execute a mode and send a control signal to the wireless transmitter, such that the wireless transmitter will input a signal into the computer system to execute the corresponding application program, so that the wireless phone can transmit control commands directly to the computer system, and the wireless phone can achieve the effects of conducting a wireless remote-control presentation, a multimedia playback, and a data transmission or synchronization.

Since a key on the wireless phone is selected and pressed to execute a mode and send a control signal to the wireless transmitter, the wireless transmitter inputs the signal to the computer system, and the computer system executes the corresponding application program, therefore the wireless phone can transmit control commands to the computer system directly, and the wireless phone can achieve the effects of conducting a wireless remote-control presentation, a multimedia playback, and a data transmission or synchronization.

### BRIEF DESCRIPTION OF THE DRAWINGS

FIG. 1 shows an application of the invention;

FIG. 2 shows a first preferred embodiment of the invention;

FIG. 3 shows a second preferred embodiment of the invention;

FIG. 4 shows a third preferred embodiment of the invention; and

FIG. 5 shows a fourth preferred embodiment of the invention.

### DETAILED DESCRIPTION OF THE PREFERRED EMBODIMENTS

To make it easier for our examiner to understand the objective, features, and performance of the present invention, we use a preferred embodiment together with the attached drawings for the detailed description of the invention.

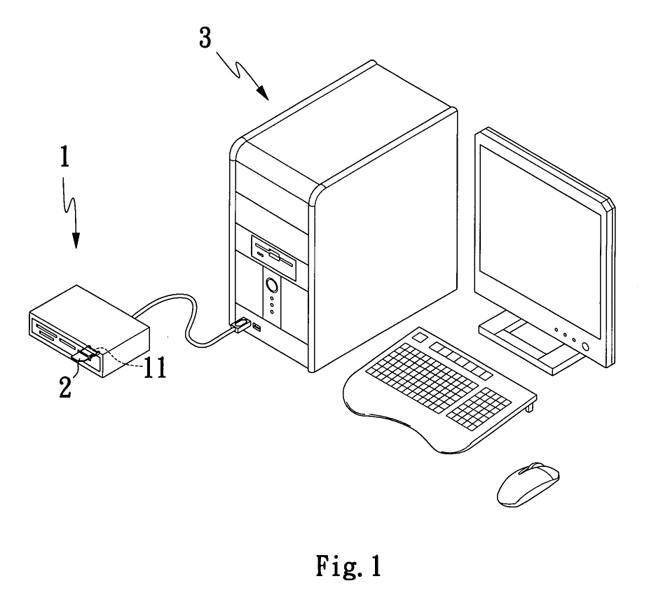

Referring to FIGS. 1 to 5 for the diagrams of an application, a first preferred embodiment, a second preferred embodiment, a third preferred embodiment, and a fourth preferred embodiment of the invention respectively, the wireless network phone of the invention comprises:

a wireless transmitter (or a wireless dongle) 1, coupled to a USB socket of a computer system 3 through a USB plug of the wireless transmitter 1; and

a wireless phone 2, for transmitting data signals with the wireless transmitter 1, wherein the wireless phone 2 includes a network dialing/receiving telephone mode, a PowerPoint presentation mode, a multimedia mode, and a file/data mode, and a press key can be switched to select the desired mode.

A key on the wireless phone 2 is selected and pressed to execute a mode and send a control signal to the wireless transmitter 1, and then the wireless transmitter 1 will input the signal to the computer system 3, such that the computer system 3 will execute the corresponding application program.

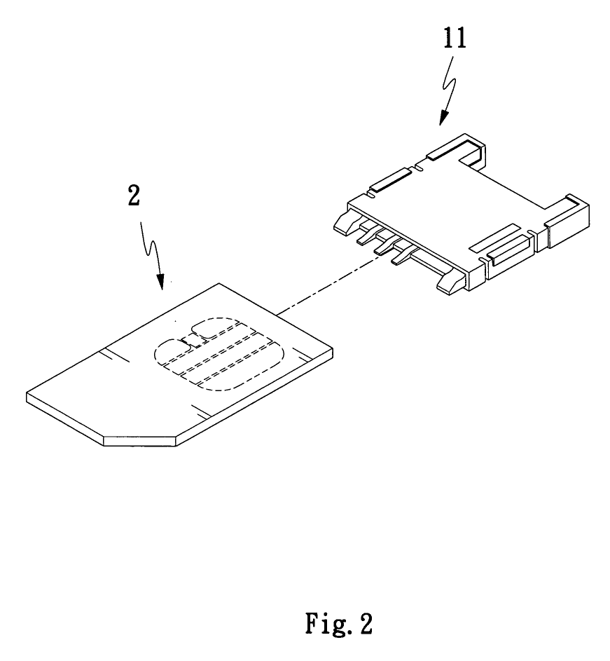

If a user switches the wireless phone 2 to a telephone mode, the wireless phone 2 will become a network phone, and each press key of the wireless phone 2 is defined as a press key of a general telephone key (as shown in FIG. 2) for dialing or receiving phone calls.

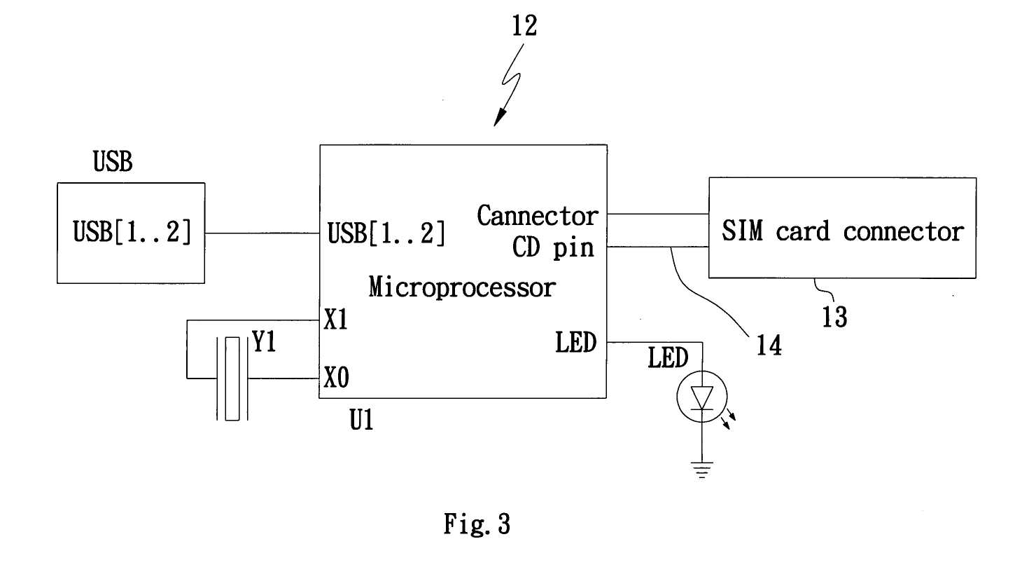

If a user switch the wireless phone to a multimedia mode (as shown in FIG. 3), the user can use the wireless phone 2 for playing music. If the wireless phone 2 comes with a display device (not shown in the figure), the wireless phone 2 can play video animations, or a direction keys of the wireless phone 2 can be used for browsing and selecting music stored in a computer and playing the music by the system. The user also can listen to the music from the wireless phone 2 and carry out the operations such as selecting or pausing the music playback.

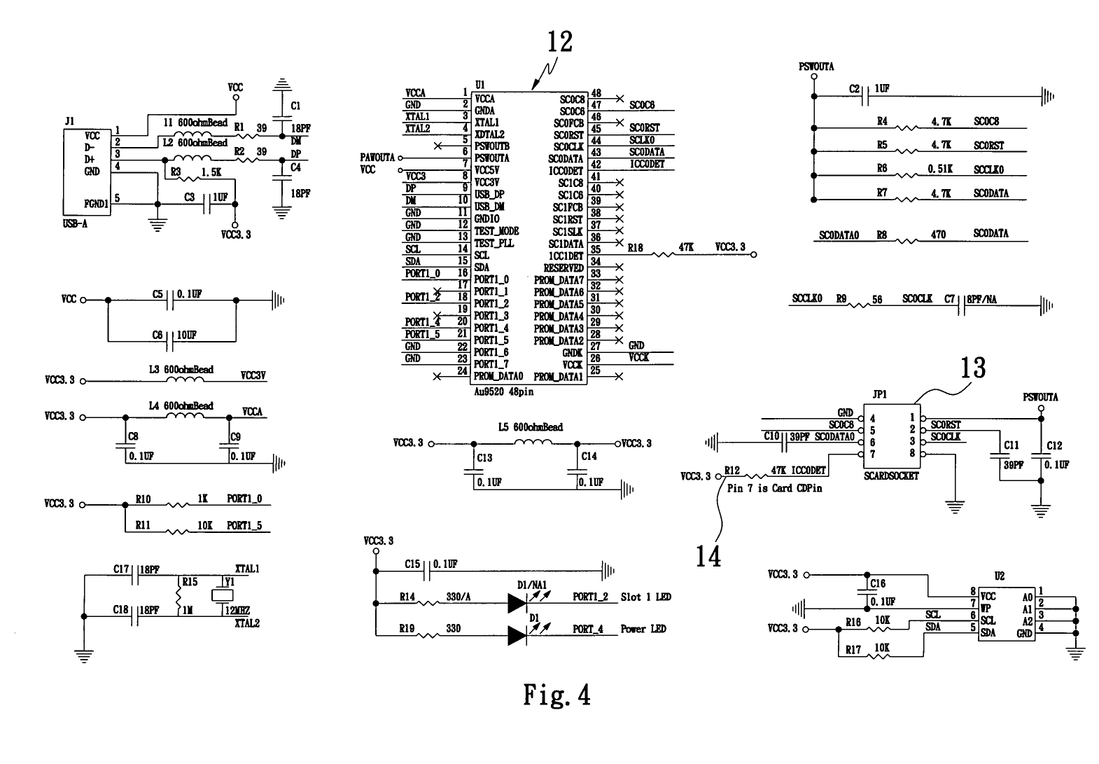

If a user switches the wireless phone 2 to a data mode, the user can download data from Outlook in a computer system 3 and start a data transmission or synchronization for the wireless phone 2 (as shown in FIG. 4) or open a directory.

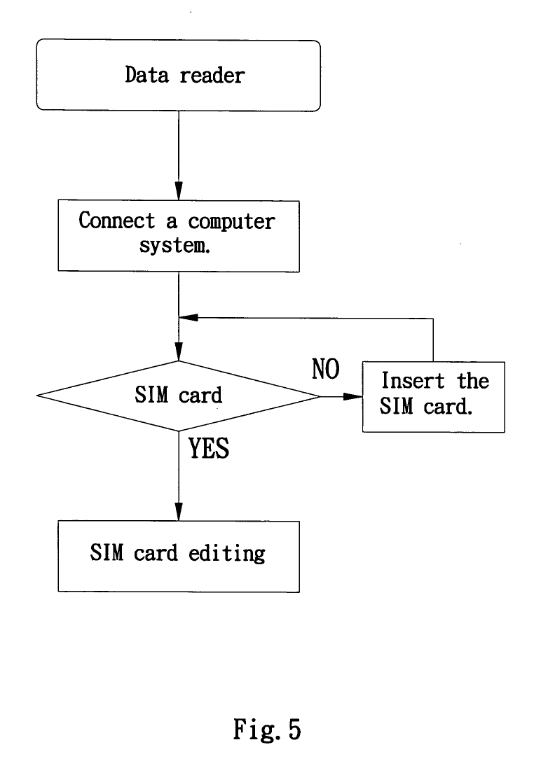

If a user switches the wireless phone 2 to a presentation mode, the wireless phone 2 will become a wireless remote controller for the presentation. By pressing the press keys on the wireless phone 2, a user can execute the operations for conducting a presentation (as shown in FIG. 5). Further, the wireless phone 2 also can come with a laser pen device (not shown in the figure), such that after the wireless phone 2 starts the presentation mode, the laser pen device is started as well to give an additional function of a laser pointer while conducing the presentation.

With the design of the present invention, a program can be used to control a computer system to execute the corresponding package software or application program such as PowerPoint, MediaPlayer, Outlook, and Skype etc. These programs receive a control corresponding to a functional key of the wireless phone 2 through a USB wireless dongle 1, and thus users can control their desired programs, and several electronic products can be integrated into the wireless phone 2. The present invention definitely can transmit control command directly from the wireless phone to the computer system, so that the wireless phone can have the functions of conducting a wireless remote-control presentation, a multimedia playback, and a data transmission or synchronization.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wireless network phone, comprising a wireless transmitter coupled to a computer system and a wireless phone coupled to said wireless transmitter for transmitting data signals, wherein said wireless phone includes a network dialing/receiving telephone mode and a multimedia mode for downloading network information to said wireless phone for a playback, and a key on said wireless phone is selected to execute a mode and send a control signal to said wireless transmitter, and said wireless transmitter sends a signal to said computer system, such that said computer system executes a corresponding application program.

2. The wireless network phone of claim 1, wherein said wireless phone further comprises a PowerPoint presentation mode, such that said wireless phone can execute a wireless remote controller for a presentation.

3. The wireless network phone of claim 1, wherein said wireless phone further comprises a display device for playing a video animation.

4. The wireless network phone of claims 1 or 3, wherein said wireless phone further comprises a data mode for downloading a data of Outlook in said computer system and opening a directory of said wireless phone.

5. The wireless network phone of claim 2, wherein said wireless phone further comprises a laser light pen device, such that after said wireless phone starts said presentation mode, said laser light pen device is started to carry out a presentation and providing the function of a laser pointer.
